(19) United States
(12) Patent Application Publication
(10) Pub. No.: US 2016/0258805 A1
(43) Pub. Date: Sep. 8, 2016

(54) Fill Level Sensor

(71) Applicant: CONTINENTAL AUTOMOTIVE GMBH, Hannover (DE)

(72) Inventors: Erich MATTMANN, Heidesheim (DE); Gerhard KALLWEIT, Frankfurt (DE); Robert PETER, Sulzbach (DE)

(21) Appl. No.: 15/029,213

(22) PCT Filed: Oct. 13, 2014
(86) PCT No.: PCT/EP2014/071883

§ 371 Date: Apr. 13, 2016

(30) Foreign Application Priority Data
Oct. 14, 2013 (DE) 10 2013 220 645.3

(51) Int. Cl. G01F 23/36

(52) U.S. Cl. CPC G01F 23/36

(57) ABSTRACT

A fill level sensor for a fuel tank of a motor vehicle includes electrical structures that consist of different materials. Sliding contact track structures exposed to the fuel consist of a gold-containing paste. Conductor structures are protected by a cover from contact with the fuel and consist of an especially inexpensive material. The fill level sensor therefore is highly resistant to corrosive fuels and can be produced at low cost.

### CROSS REFERENCE TO RELATED APPLICATIONS

This is a U.S. national stage of application No. PCT/EP2014/071883, filed on Oct. 13, 2014. Priority is claimed on German Application No. DE102103220645.3, filed Oct. 14, 2013, the content of which is incorporated here by reference.

### BACKGROUND OF THE INVENTION

1. Field of the Invention

The invention relates to a fill level sensor for a fuel container of a motor vehicle having a carrier element, a potentiometer for detecting a fill level, sliding track structures of the potentiometer arranged on the carrier element, and line structures which are arranged on the carrier element.

2. Description of the Prior Art

Fill level sensors of this type are frequently used in fuel containers of modern motor vehicles and are known from practice. As a result of the arrangement in the fuel container, the structures arranged on the carrier element are exposed to the fuel. Fuels containing alcohol are usually very corrosive. Therefore, particularly corrosion-resistant materials containing gold are used in the known fill level sensors for the structures applied on the carrier element. Materials of this type are very expensive. Inexpensive materials containing silver for the structures would lead to rapid corrosion of the structures exposed to the fuel.

### SUMMARY OF THE INVENTION

One aspect of the invention is based on designing a fill level sensor of the type mentioned at the outset such that it can be manufactured particularly inexpensively and has a high resistance to corrosion by fuels.

According to one aspect of the invention, the problem is solved by virtue of the fact that the sliding track structures are manufactured from a corrosion-resistant conductive material, and the line structures are manufactured from a particularly inexpensive material in comparison with the corrosion-resistant material, and that the line structures have a covering made from a corrosion-resistant material.

As a result of this design, the structures applied on the carrier element are manufactured from different materials. Structures of this type, which have to be accessible for tapping off by sliding contacts, are therefore exposed to the contact with fuel and are manufactured according one aspect of to the invention from a particularly corrosion-resistant and therefore usually expensive material. Simple line structures are protected, however, by way of the covering against contact with fuel and are manufactured from an inexpensive material. As a result, the fill level sensor has a particularly high resistance to corrosion by fuels and can be manufactured particularly inexpensively.

According to one aspect of the invention, the sliding track structures exposed to the fuel have a durable protection against corrosive fuels if the sliding track structures are manufactured from a precious metal paste containing gold.

According to one aspect of the invention, the line structures protected against the corrosive fuel by way of the covering can be manufactured particularly inexpensively if the line structures are manufactured from a paste containing silver. On account of the protective action against corrosive fuel produced by way of the covering, the low corrosion resistance of the pastes containing silver is not of significance.

According to one aspect of the invention, the covering can be applied on the carrier element particularly inexpensively and over a large area if the covering is configured as a sintered protective glaze. To this end, a protective glass is applied, for example by way of printing, on the regions of the carrier element that are not occupied by the sliding track structures. The protective glaze is produced in a further sintering process at temperatures of over 600° C.

According to one aspect of the invention, the covering can be produced without an additional sintering step if the covering is produced from a resistor paste. Resistor pastes of this type can be printed simply over the feed lines which are likewise printed onto the carrier element. The line structures and the covering are sintered jointly in one step. In this way, a reliable separation of the line structures from the fuel is achieved. A parallel resistance is produced as a result of the applied resistor paste, which parallel resistance can be calculated according to Ohm's law. The parallel resistance therefore has no disadvantageous influence on the fill level sensor.

According to one aspect of the invention, the line structures are protected reliably against contact with fuel if the covering, which is produced from the resistor paste, has a thickness of at least 500 μm.

According to one aspect of the invention, a contribution is made to further reducing the manufacturing costs of the fill level sensor if resistance structures arranged on the carrier element are manufactured from a ruthenium(IV) oxide paste. If the resistances in the sliding track structures are of sufficiently high impedance, preferably greater than 1 kilo-ohm, the resistance structures can also replace at least part of the line structures.

According to one aspect of the invention, the electric connection of the structures manufactured from different materials is of particularly simple design if the line structures and the sliding track structures have an overlap.

Overlaps of structures lead to elevations which also have to be covered by the covering. According to one aspect of the invention elevations of the structures can be avoided simply if the line structures and the sliding track structures have a region, in which they engage into one another in a comb-shaped manner.

### BRIEF DESCRIPTION OF THE DRAWINGS

The invention permits numerous embodiments. For further clarification of its fundamental principle, one of them is shown in the drawing and will be described in the following text. In the drawing:

FIG. 1 diagrammatically depicts a fill level sensor;

FIG. 2 is a carrier of the fill level sensor from FIG. 1;

FIG. 3a shows an electric connection of two different structures;

FIG. 3b is a sectional illustration through the connection from FIG. 3a along the line IIIb-IIIb;

FIG. 4a is a further embodiment of the connection of two different structures; and

FIG. 4b is a sectional illustration through the connection from FIG. 4a along the line IVb-IVb.

### DETAILED DESCRIPTION OF THE PRESENTLY PREFERRED EMBODIMENTS

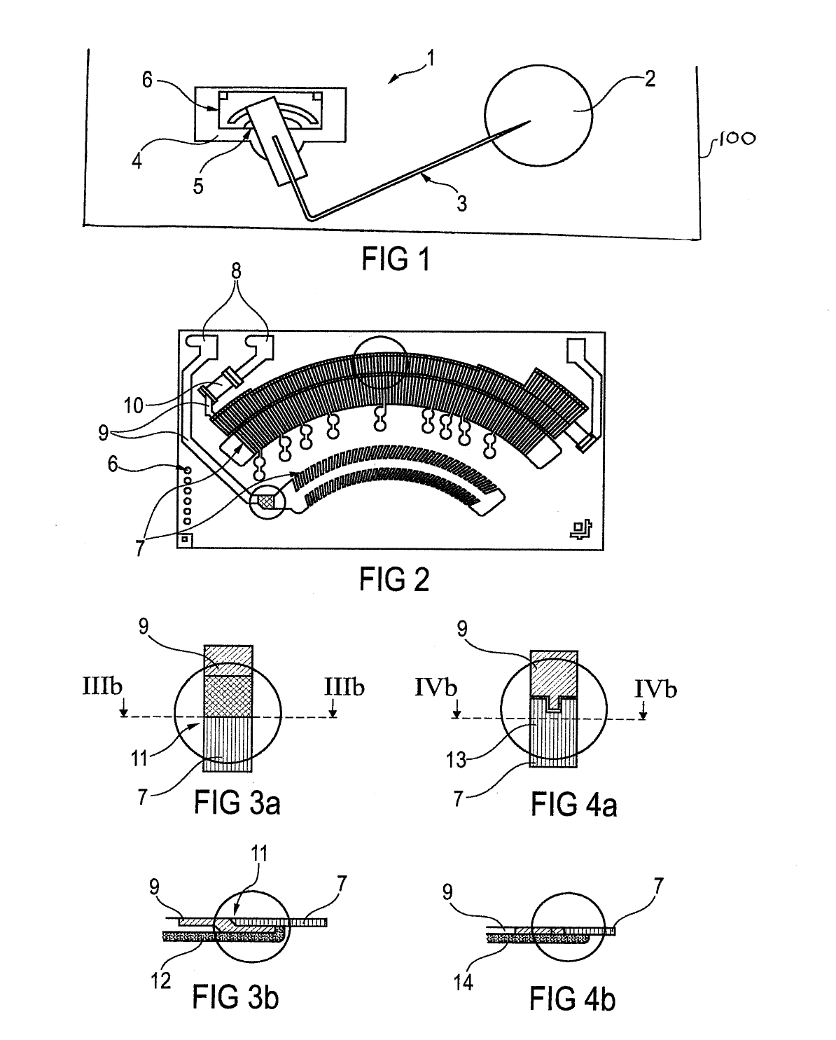

FIG. 1 shows a fill level sensor 1 having a lever arm 3 that secures a float 2. The fill level sensor 1 is provided for use in a fuel container 100. The lever arm 3 is mounted pivotably on a carrier 4 and is deflected in a manner dependent on a fill level of fuel which is arranged in the fuel container 100. The deflection of the lever arm 3 is detected by a potentiometer 5. The potentiometer 5 has a carrier element 6 arranged on the carrier 4.

The carrier element 6 of the potentiometer 5 is shown on an enlarged scale in FIG. 2. Functional structures such as sliding track structures 7 and electric connector surfaces 8 are arranged on the carrier element 6. Furthermore, the carrier element 6 has inactive structures such as line structures 9 of feed lines, supporting and paddle lug tracks in the resistance region. A resistant structure 10 forms an ohmic resistance in a line structure 9. A contact bridge (not shown) arranged on the lever arm 3 slides over the sliding track structures 7. The signals of the potentiometer 5 can be tapped off at the electric connector surfaces 8. The sliding track structures 7 and the structures of the electric connector surfaces 8 are freely accessible to this end and are therefore exposed to the fuel.

FIG. 3a shows a connection of the line structures 9 to the sliding track structures 7 or the structures of the connector surfaces 8. As FIG. 3b shows in a sectional illustration through the connection from FIG. 3a, the line structures 9 and the sliding track structures 7 have an overlap 11 for their electric connection. The region of the overlap 11 and the line structures 9 are covered with a covering 12. The covering 12 prevents contact of the line structures 9 with the fuel that surrounds the fill level sensor 1.

FIG. 4a shows a further embodiment of the connection of the line structures 9 to the sliding track structures 7 or the structures for the connector surface 8. For their electric connection, the line structures 9 and the sliding track structures 7 have a region 13, in which they engage into one another in a comb-like manner. As FIG. 4b shows in a sectional illustration through the connection from FIG. 4a along the line IVb-IVb, the sliding track structures 7 and the line structures 9 form one plane. The region 13 of the comb-like engagement into one another and the line structures 9 are covered by a covering 14. The covering 14 prevents contact of the covered structures with the fuel that surrounds the fill level sensor 1.

As a result of the covering 12, 14, the structures that lie underneath, such as the line structures 9, can be manufactured from an inexpensive material that is not fuel-resistant. A paste containing silver, for example, is known as a material of this type. The necessarily accessible structures such as the sliding track structures 7 or the structures of the connector surfaces 8 are manufactured from a fuel-resistant paste, preferably containing gold.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A fill level sensor for a fuel container, comprising:
a carrier element;
a potentiometer configured to detect a fill level;
sliding track structures of the potentiometer arranged on the carrier element manufactured from a corrosion-resistant conductive material having a first cost;
line structures arranged on the carrier element manufactured from an inexpensive material having a second cost that is less than the first cost; and
a covering on the line structures made from a corrosion-resistant material.

11. The fill level sensor as claimed in claim 10, wherein the sliding track structures are manufactured from a precious metal paste containing gold.

12. The fill level sensor as claimed in claim 10, wherein the line structures are manufactured from a paste containing silver.

13. The fill level sensor as claimed in claim 10, wherein the covering is a sintered protective glaze.

14. The fill level sensor as claimed in claim 10, wherein the covering is a resistor paste.

15. The fill level sensor as claimed in claim 14, wherein the covering produced from the resistor paste has a thickness of at least 500 μm.

16. The fill level sensor as claimed in claim 10, further comprising resistance structures arranged on the carrier element manufactured from a ruthenium oxide paste.

17. The fill level sensor as claimed in claim 10, wherein the line structures and the sliding track structures have an overlap.

18. The fill level sensor as claimed in claim 10, wherein the line structures and the sliding track structures have a region, in which they engage into one another in a comb-shaped manner.

19. The fill level sensor as claimed in claim 11, wherein the line structures are manufactured from a paste containing silver.

20. The fill level sensor as claimed in claim 19, wherein the covering is a sintered protective glaze.

21. The fill level sensor as claimed in claim 20, wherein the covering is a resistor paste.

22. The fill level sensor as claimed in claim 21, further comprising resistance structures arranged on the carrier element manufactured from a ruthenium oxide paste.

23. The fill level sensor as claimed in claim 22, wherein the covering produced from the resistor paste has a thickness of at least 500 μm.

24. The fill level sensor as claimed in claim 23, further comprising resistance structures arranged on the carrier element manufactured from a ruthenium oxide paste.

25. The fill level sensor as claimed in claim 24, wherein the line structures and the sliding track structures have an overlap.

26. The fill level sensor as claimed in claim 24, wherein the line structures and the sliding track structures have a region in which they engage into one another in a comb-shaped manner.
